(19) United States
(12) Patent Application Publication
(10) Pub. No.: US 2008/0173339 A1
(43) Pub. Date: Jul. 24, 2008

(54) METHOD FOR CLEANING SEMICONDUCTOR DEVICE

(76) Inventors: Yen-Wu HSIEH, Yang-Mei Chen (TW); Hui-Hsiung Tuan, Chung-Li City (TW)

Correspondence Address: BIRCH STEWART KOLASCH & BIRCH, PO BOX 747, FALLS CHURCH, VA, 22040-0747, US

(21) Appl. No.: 12/057,508

(22) Filed: Mar. 28, 2008

Related U.S. Application Data
(62) Division of application No. 11/086,386, filed on Mar. 23, 2005.

(30) Foreign Application Priority Data
Jul. 16, 2004 (TW) 093121421

(51) Int. Cl. B08B 13/00

(52) U.S. Cl. 134/201

(57) ABSTRACT

A method for cleaning semiconductor device is disclosed. The steps include providing a mask-protective device, providing a mask with a defined pattern, and combining the mask-protective device with the cleaned mask layer, such that the space between the mask-protective device and the mask layer can fill with the cleaning gas after combining process. Thus, the mask layer would not be polluted by the particle is generated from the environment, such that the resolution of the image and the reliability can be increased.

This application is a Divisional of co-pending application Ser. No. 11/086,386 filed Mar. 23, 2005, and for which priority is claimed under 35 U.S.C. § 120; and this application claims priority of Application No. 093121421 filed in Taiwan, R.O.C. on Jul. 16, 2004 under U.S.C. § 119; the entire contents of all are hereby incorporated by reference.

### BACKGROUND OF THE INVENTION

1. Field of the Invention

The present invention generally relates to a method for cleaning the semiconductor device, and more particularly to a method utilizes purge gas to clean the mask with patterns, such that the mask with patterns can prevent pollution from the growing defects.

2. Description of the Prior Art

Photolithography is a process frequently used in processes to manufacture semiconductor devices. During the photolithography process, a light-sensitive layer on a semiconductor device is selectively exposed to the light through the use of a reticle or mask. The light is transmitted toward the light-sensitive layer through the reticle, which contains transparent regions that transmit light to the light-sensitive layer and opaque regions that prevent exposure of certain area of the light-sensitive layer to the light. Typically, the reticle is a transparent quartz plate with a pattern defined by opaque material included on one side of the quartz plate. The transparent and opaque regions are associated with circuitry to be created on the semiconductor device. The exposed portions of the light-sensitive layer are transformed, allowing them to remove by solvents, to create the circuitry of the semiconductor device.

Referring to FIG. 1A to FIG. 1C, show the prior art mask and mask-protective device system. FIG. 1A shows a mask 110 with a pattern 120 thereon or therein. In the conventional technology, a specific pattern 120 of the integrated circuit is defined on the mask 110, and a mask inspection process is performed after removing the photoresist layer (not shown). As if the mask without any defect, the mask-protective device 130 could be located on the mask 110 to isolate the particles that is generated from the environment. Although the particle is full down the top of the membrane 132 of the mask-protective device 130, however, the distance between the particle and the mask is out of the focus of the patterns on mask during the expose process. Thus, the resolution and the reliability of the wafer could not be affected during the pattern transformation.

As abovementioned, the defect is not an issue when the wavelength of the exposure light source is 248 nm. Nevertheless, due to the energy of the exposure light source is increased to a shorter wavelength of 193 nm, and the environment of the scanner is not suitable for the scanning process, the photoresist outgas and contaminants from the environment would be generated and diffused though the vent hole 134 of the mask-protective device 130 to the mask 110 and within the mask-protective device 130. Then, the photochemistry reaction would be reacted to generate the reaction product (or particle) 140, and the reaction product (particle) 140 would be adhered on the mask 110. Thus, this reaction product 140 could be a growing defect (as shown in FIG. 1B). Due to the particle 140 would affect the image on the wafer during the exposing process, thus, the reliability of the wafer is reduced.

### SUMMARY OF THE INVENTION

It is an object of this invention to utilize the purge gas to clean and prevent growing defects for the mask with pattern. Then, the mask-protective device is combined with the mask has pattern of the integrated circuit, such that the purge gas full with the space between the mask-protective device and the mask with the pattern. Thus, the cleaning process can ensure the mask with the pattern against the particle and chemical pollution which is generated from the environment.

It is a further object of this invention to reduce the particle adheres on the mask by using the purge gas to clean the mask with pattern, such that the resolution and the reliability for the transforming pattern to the wafer would not be affected.

According to abovementioned objects, the present invention provides a method for cleaning the semiconductor device. The steps includes providing a mask-protective device, a mask with the pattern, a purge gas used to clean the mask with the pattern to remove the particle on the top of the mask with the pattern, and the mask-protective device is combined the mask with the pattern. Thus, the space between the mask and the mask-protective device is full the purge gas after combining process. Therefore, the cleaning process of the purge gas can ensure the mask with the pattern against the particle pollution which is generated from the environment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A to FIG. 1C are schematic representation of the mask and mask-protective device system in accordance with the conventional prior art;

FIG. 2 is a flow diagram showing the steps for cleaning the semiconductor device in accordance with a method disclosed herein; and

FIG. 3A to 3C are schematic representations of the steps of the cleaning the semiconductor device in accordance with the method disclosed herein.

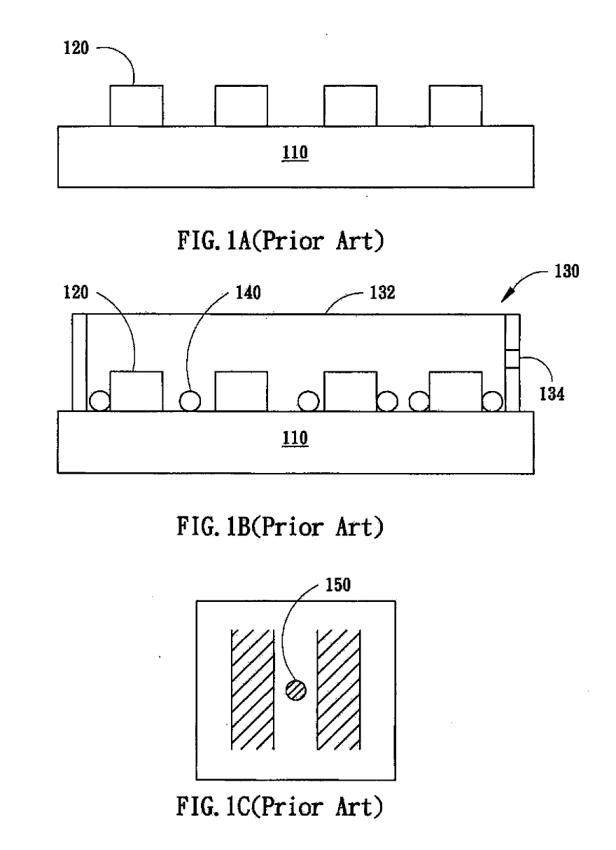

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to the conventional prior art, in order to prevent the mask from the particle pollution that is generated from the environment to affect the resolution and the reliability for pattern of the wafer, the present invention provides a device and a method for cleaning the semiconductor device. The objective is to control the environment between the mask and the mask-protective device after the combining the mask and mask-protective device, and the particle located on the mask is to be removed, so as to the resolution and the reliability of the wafer would not be affected during the exposure process.

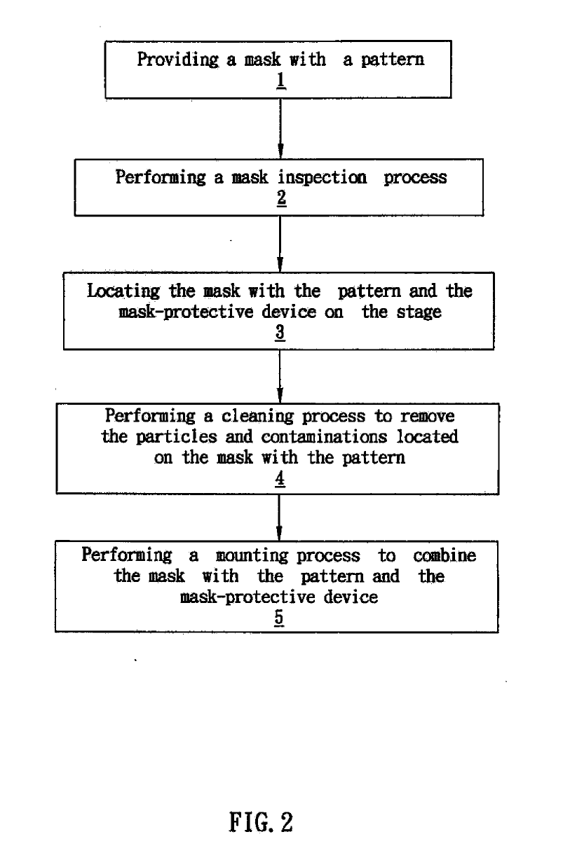

Referring to FIG. 2 shows a flow chart of cleaning semiconductor device. Step 1 denotes providing a mask with a pattern. Step 2 denotes performing a mask inspection process. Step 3 denotes locating the mask with the pattern and a mask-protective device on the stage. Step 4 denotes performing a cleaning process to remove the particle which is located on the top of the mask, and at the same time, the mask-protective device is full the purge gas. Step 5 denotes performing a mounting process to combine the mask with the pattern and the mask-protective device, such that the space between the mask and the mask-protective device is full purge gas. Thus, according to above steps, the purge gas existed in the space between the mask and the mask-protective device, thus, the cleaning level of the mounting environment can be controlled. Furthermore, the photoresist outgas and contaminations from the environment would not be able to diffuse into the combined mask and the mask-protective device to induce the photochemical reaction.

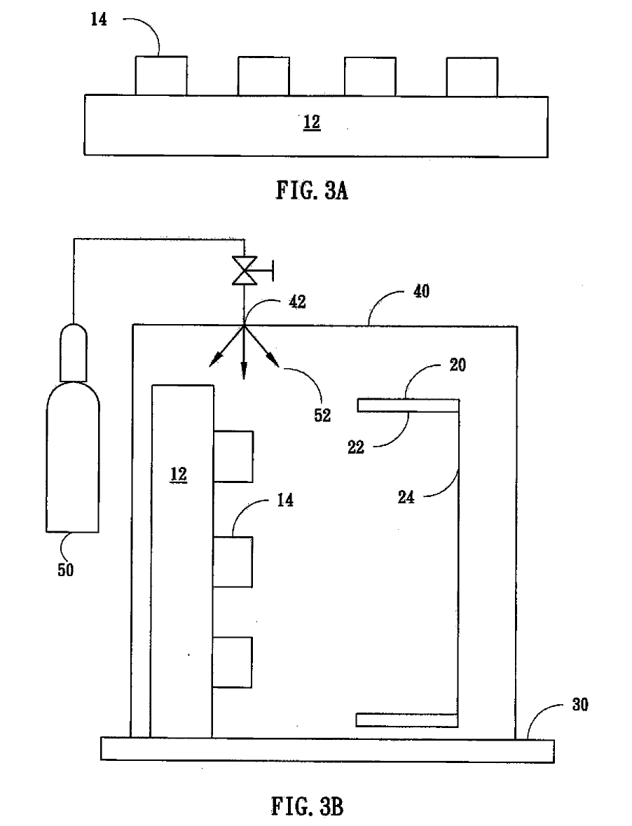

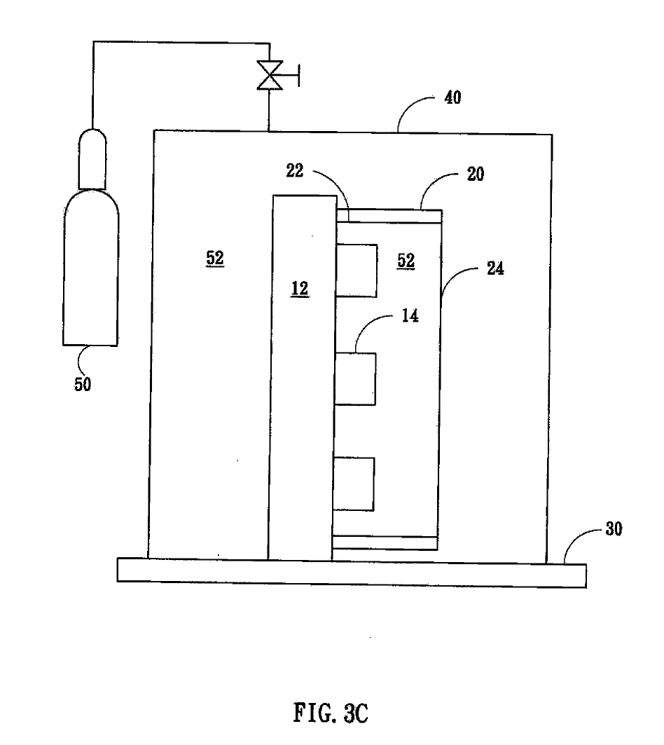

Referring to FIG. 3A to FIG. 3C show the steps for cleaning the semiconductor device. As shown in FIG. 3A, a mask 12 has a pattern 14 is provided. The pattern 14 is obtained by well-known process, which includes a photoresist layer (not shown) is formed on the mask 12. Then, the photoresist layer is patterned to etch, and defined the specific pattern, such as integrated circuit pattern on the mask 12. Next, a mask inspection process is performed to inspect the defect on the mask 12.

Next, as shown in FIG. 3B, the mask 12 has pattern 14 and the mask-protective device 20 are located in the chamber 40 which is on the stage 30, wherein the chamber 40 has a vent hole 42. The mask-protective device 20 is constructed of the rigid frame 22 and a membrane 24, wherein the membrane 24 is located on the rigid frame 22, the purpose of the membrane is used to prevent the mask 12 that is polluted from the materials which is generated from the process environment. Furthermore, the membrane 24 is a transparent membrane which would not be affected the image that transformed the pattern on the wafer during the exposure process, and the material of the membrane is a fluorine-containing polymer.

Then, a cleaning device 50 supplied the purge gas 52 that induced through the vent hole 42 of the chamber 40 to the chamber 40. Therefore, the purge gas 52 is full between the mask 12 with the pattern 14 and the mask-protective device 20. At meanwhile, after the purge gas 52 introduced into the chamber 40, the purge gas 52 can clean the particle or other materials on the mask 12 with the pattern 14. On the other hand, the mask-protective device 30 is also to be cleaned by the purge gas 52, such that the cleaning level of the mask-protective device 30 can be maintained. Herein, the purge gas 52 can be an inert gas, such as nitrogen gas (N₂), argon (Ar), or helium (He) and so on.

When the purge gas 52 introduced from the cleaning device 50 into the chamber 40, which the volume is 80*50*100 cm³, the flow rate of the purge gas 52 is about 5 to 50 liter per minutes (L/min), the duration for the chamber 40 is full with the purge gas 52 that is about 5 to 10 minutes, and the remaining oxygen concentration is less than 5%. Next, the vent hole 42 of the chamber 40 is closed, and then the cleaning device 50 is turned off. Thereafter, the mask-protective device 30 within the chamber 40 is combined the mask 12 with the pattern 14, such that the mask-protective device 30 could be combined tightly. Therefore, a small space between the mask-protective device 30 and the mask 12 with the pattern 14 is full with the purge gas 52.

Herein, it is noticed that the sidewall of the mask-protective device 30 further includes a vent hole, such that the portion of the purge gas 52 would be diffused through the vent hole to the outside environment of the chamber 40. Thus, the pressure within the chamber 40 is equalized to the outside environment, and the concentration of the purge gas 52 within the chamber 40 also could be reduced. Herein, the preferred embodiment of the mask-protective device 30 with vent hole is similar to the mask-protective device 30 without vent hole, thus, the statement of the mask-protective device 30 with vent hole no longer duplicated.

According to abovementioned, the present invention provides a purge gas 52 to clean the particle or other unnecessary materials and contaminations which located on the mask 12 with pattern 14. Furthermore, due to the purge gas 52 is full between the mask 12 and the mask-protective device 30 after combing processing, the photochemical reaction can be prevented, even though the photoresist outgas and other contaminations outside the mask and mask-protective device in storage or during exposure process.

Although specific embodiments have been illustrated and described, it will be obvious to those skilled in the art that various modifications may be made without departing from what is intended to be limited solely by the appended claims.

What is claimed is:

1. A device for cleaning semiconductor device, said device comprising:
a stage;
a chamber with a vent hole, said chamber with said vent hole locating above on said stage, and a mask-protective device and a mask with a pattern locating within said chamber with said vent hole, wherein the space is between said mask with said pattern and said mask-protective device; and
a cleaning device, said cleaning device supplying a purge gas that introducing through said vent hole of said chamber into said chamber.

2. The device according to claim 1, wherein said purge gas used to clean said mask with said pattern.

3. The device according to claim 1, wherein said purge gas used to fill said mask with said pattern and said mask-protective device.

4. The device according to claim 1, wherein said purge gas is nitrogen gas.

5. The device according to claim 1, wherein said purge gas is helium gas.

6. The device according to claim 1, wherein said purge gas is argon gas.

7. The device according to claim 1, wherein said purge gas is an inert gas.
